(19) United States
(12) Patent Application Publication
(10) Pub. No.: US 2026/0144241 A1
(43) Pub. Date: May 28, 2026

(54) DOWNRIGGER WEIGHT CLIP

(71) Applicant: Evgenij Nikolaevich ERMOLAEV, Murmanskaya oblast', g.Apatity (RU)

(72) Inventor: Evgenij Nikolaevich ERMOLAEV, Murmanskaya oblast', g.Apatity (RU)

(21) Appl. No.: 19/123,212

(22) PCT Filed: Jan. 3, 2024
(86) PCT No.: PCT/RU2024/050001

§ 371 Date: Apr. 22, 2025

(30) Foreign Application Priority Data
Jan. 11, 2023 (RU) 2023100366

(51) Int. Cl. A01K 91/08

(52) U.S. Cl. CPC A01K 91/08

(57) ABSTRACT

A cargo clip for a downrigger includes a housing consisting of a cover and a base, a pivoting clip with lower and upper jaws connected by an axis, and an adjustment system consisting of a latch, spring, and adjustment screw. The rotation screw on the lower jaw and its corresponding hole on the upper jaw form asymmetrical arms of different lengths. Friction pads are attached to the opposite ends of the lower jaw, while a tooth on the upper jaw engages a projection on the housing cover.

### DESCRIPTION

The invention relates to fishing, specifically to angling using a downrigger, and can be used to hold the fishing line and bait underwater at the desired depth during trolling.

The most common device for securing the position of trolling bait on a downrigger weight is the Scotty 1170 type clip (https://www.badger.ru/catalog/trolling/daunriggery/klipsy/121299, accessed: Jan. 9, 2023), equipped with soft pads and a regulator that doubles (increases) the holding force. The line release force from the clip is adjusted by the position of the line within the pads, and the streamlined shape prevents it from snagging on grass or debris. However, the disadvantages of such devices are:
Identical triggering force on both ends of the line, which increases as it moves toward the upper end of the line due to water resistance and depends on the speed and depth of immersion, often exceeding the force of a small fish strike by 2-3 times.
Lack of precise adjustment of the device's triggering force.

A known device for attaching to a downrigger line prevents line sagging. It comprises: a release mechanism that holds the line until a fish bites and releases it afterward; a rotating board that turns around a vertical axis passing through the board, allowing the device to change depth after a fish bite; a loop that lets the device move along the downrigger line as it shortens, thereby preventing line sagging (Refer to patent U.S. Pat. No. 8,695,271, IPC A01K 91/04, application date: Jun. 12, 2007, patent issuance date: Apr. 15, 2014.). Disadvantage of this device also has the drawback of identical triggering force on both ends of the line, which increases due to water resistance and the depth and often exceeds the force of a small fish strike by 2-3 times.

The closest analogue with the same purpose to the proposed utility model is a downrigger device for trolling that includes: A bifurcated clamp, wherein this clamp consist with a rear end part and a pair of transversely spaced cantilever beams extending from the rear end part, forming a channel and ending in deflectable front ends; an axially stretchable spring connecting the rear end part to a weighted bottom line; a “scissor-like” release clamp for detachably holding the line, consisting of a lever holder and a release lever pivotally attached to the lever holder's rear end, designed to pivot between line-holding and line-releasing positions wherein the front end of said lever holder is releasably engaged in said channel when the release lever is in said line holding position, a first retaining means for retaining the front end of said lever holder in said channel and releasing said lever holder when a predetermined force in said spring is exceeded, and a second retaining means for releasably retaining the front end of said release lever in said line holding position (Refer to patent U.S. Pat. No. 7,197,847, IPC A01K 91/00, A 01K 91/08, application date: Oct. 27, 2004, patent issuance date: Apr. 3, 2007.) This device also has the following disadvantages:
identical triggering force on both ends of the line, which increases due to water resistance and exceeds the force of a small fish strike by 2-3 times.
bulky construction with detachable components.
the need for additional skill during operation to thread the line.

The objective is to eliminate the above-mentioned drawbacks:

The technical result is improved clip triggering efficiency with minimal impact on the bait and the prevention of unintentional clip triggering due to speed changes or increased immersion depth.

Solution for the objective and the technical result is achieved with the proposed cargo clip for a downrigger includes a housing consisting of a cover and a base, a pivoting clip with lower and upper jaws connected by an axis, and an adjustment system consisting of a latch, spring, and adjustment screw. The rotation screw on the lower jaw and its corresponding hole on the upper jaw form asymmetrical arms of different lengths. Friction pads are attached to the opposite ends of the lower jaw, while a tooth on the upper jaw engages a projection on the housing cover.

Main feature of this devices is its asymmetrical clip arms, which differentiate the effort needed to rotate and open the clip. The difference in arm length ratios is proportional to the difference between the force of a minimal fish strike or water resistance. The adjustment screw allows the spring's compression force to be modified, adjusting the triggering force. Friction pads on the lower jaw prevent slippage of lines of various thicknesses.

A notch on the lower jaw, interacting with the latch, can be made asymmetrical. This technical solution further differentiates the triggering forces when rotating the clip in one direction or the other.

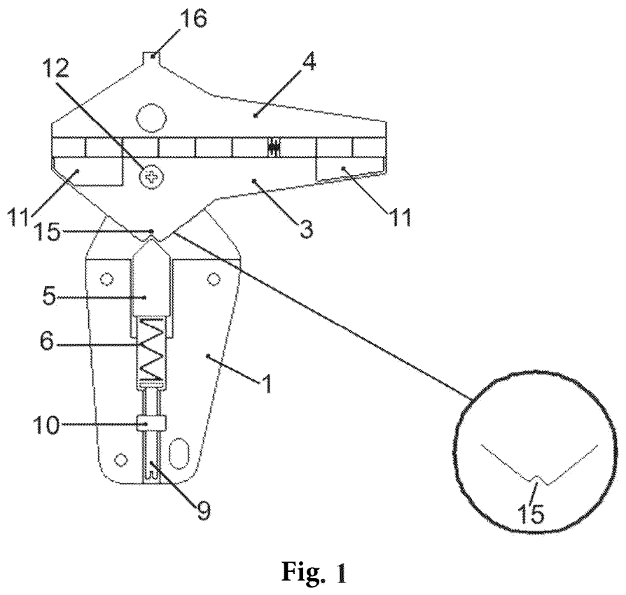

Device is provided on FIGS. 1-3:

FIG. 1: Front view in an open position without the housing cover.

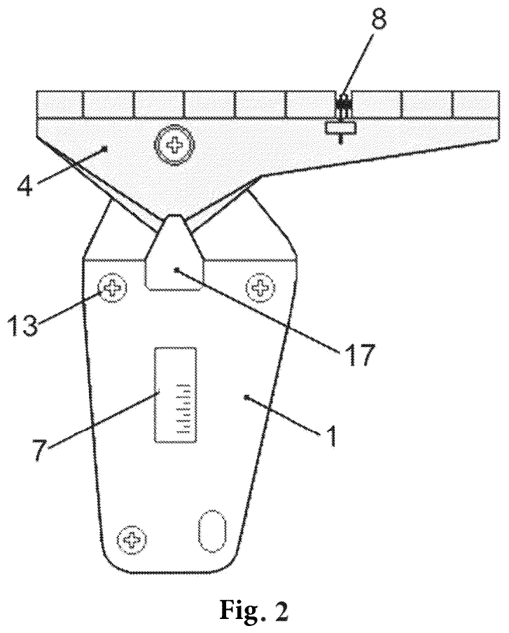

FIG. 2: Front view in working position with the housing cover.

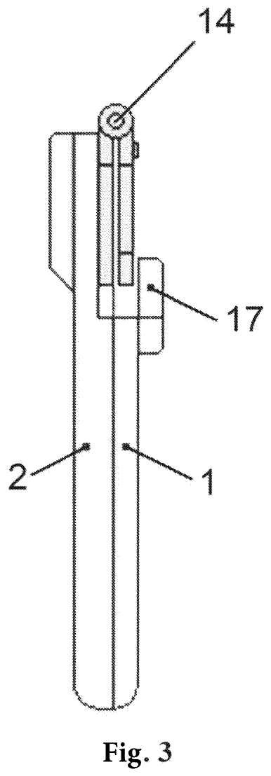

FIG. 3: Left view in working position with the housing cover.

With a following designations:
1—Housing cover
2—Housing base
3—Lower jaw
4—Upper jaw
5—Latch
6, 8—Spring
7—Transparent cover
9—Adjustment screw
10—Nut
11—Friction pad
12—Rotation screw
13—Fastening screw
14—Axis
15—Notch
16—Tooth
17—Projection

The cargo clip for the downrigger includes a housing consisting of a housing cover 1 with a transparent cover 7 and a housing base 2 connected to each other by fastening screws 13, a rotary clip with lower jaw 3 and upper 4 jaw connected by means of an axis 14, and an adjustment system in the form of a latch 5, a spring and an adjustment screw 9 passing through a nut 10. The clip rotation screw 12 on the lower jaw 3 of the clip and the corresponding hole on the upper jaw 4 of the clip are arranged to form shoulders that are asymmetrical in length. Friction pads 11 are fixed to opposite ends of the lower jaw of the clip 3.

The device is attached to the downrigger load with a leash and brought to the open position (FIG. 1). The line is inserted between the lower 3 jaw and upper 4 jaw of the clip, and they are closed. Thus, the clip is brought to the working position (FIGS. 2 and 3). The clip in the working position is turned until the latch 5 is triggered, which enters the notch 15 on the lower jaw of the clip 3. In this case, the tooth 16 on the upper jaw of the clip 4 engages with the projection 17 on the housing cover 1, which holds the clip in the working position. The downrigger load with the device attached to it is lowered to the required depth.

When a fish bites, the line with the bait pulls on the longer arm of the clip, causing it to rotate. The latch 5 shifts, the tooth 16 on the upper jaw 4 disengages from the projection 17 on the housing cover 1. Under the influence of spring 8, the lower 3 and upper 4 jaws of the clip open, releasing the line with the bait If it is necessary to release the line with the bait, the upper end of the line is pulled with a spinning rod, causing the clip to rotate in the opposite direction. The release process then follows the same mechanism. Depending on which arm of the clip is pulled, the force required to rotate and open the clip differs significantly.

What is claimed as:

1. The cargo clip for a downrigger includes a housing consisting of a cover and a base, a pivoting clip with lower and upper jaws connected by an axis, and an adjustment system consisting of a latch, spring, and adjustment screw wherein the rotation screw on the lower jaw and its corresponding hole on the upper jaw form asymmetrical arms of different lengths while friction pads are attached to the opposite ends of the lower jaw, while a tooth on the upper jaw engages a projection on the housing cover.

2. The clip under claim 1, wherein the notch on the lower jaw interacting with the latch is asymmetrical.
